(19) United States
(12) Patent Application Publication
(10) Pub. No.: US 2023/0316045 A1
(43) Pub. Date: Oct. 5, 2023

(54) DRIFT DETECTION USING AN AUTOENCODER WITH WEIGHTED LOSS

(71) Applicant: Microsoft Technology Licensing, LLC, Redmond, WA (US)

(72) Inventors: Kiran RAMA, Bangalore (IN); Ke LI, Redmond, WA (US)

(21) Appl. No.: 17/731,908

(22) Filed: Apr. 28, 2022

(30) Foreign Application Priority Data
Feb. 14, 2022 (IN) 202211007616

(51) Int. Cl. G06N 3/04; G06N 3/08

(52) U.S. Cl. CPC G06N 3/0454; G06N 3/08

(57) ABSTRACT

Embodiments described herein are directed to ANN-based drift detection techniques for detecting data drift. For example, feature importance values of features provided to an ML model are determined. An input feature vector comprising a plurality of feature values are provided as an input to an autoencoder, which is configured to learn encodings representative of the features provided thereto and regenerate the features based on the encodings. The loss function (or re-construction loss) of the autoencoder is weighted by the feature importance values. A re-construction error based on the weighted loss is determined. The re-construction error is compared to a threshold condition. In response to determining that the re-construction error meets the threshold condition, a determination is made that the data has drifted. Responsive to determining that data has drifted, an action is taken with respect to the ML model to mitigate the data drift.

### CROSS-REFERENCE TO RELATED APPLICATION(S)

This application claims priority to Indian Provisional Patent Application No. 202211007616 entitled “DRIFT DETECTION USING AN ARTIFICIAL NEURAL NETWORK WITH WEIGHTED LOSS,” and filed on Feb. 14, 2022, the entirety of which is incorporated by reference herein.

### BACKGROUND

Model drift refers to machine learning (ML) model performance degradation over time. Organizations depend on machine learning signals for a variety of tasks ranging from classifying entities (faulty VM (virtual machines) vs. non-faulty VM, tickets likely to be escalated vs. non-escalated, buyers vs. non-buyers, etc.), predicting important values (latency of a virtual storage network etc.), segmenting entities (grouping VMs based on their characteristics), recommender systems, forecasting future values (throughput of a virtual storage, sales, attainment, etc.) and detecting anomalies (likely failure of hard drive in a virtual storage system).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums described herein are configured to detect data drift. For example, feature importance values of features provided to a machine learning model may be determined. An input feature vector comprising a plurality of feature values are provided as an input to self-supervised neural network, such as an autoencoder, which is configured to learn encodings representative of the feature values provided thereto and regenerate the feature values based on the encodings. The loss function (or re-construction loss) of the autoencoder is weighted by the feature importance values. A re-construction error based on the weighted loss is determined. The re-construction error is compared to a threshold condition. In response to determining that the re-construction error meets the threshold condition, a determination is made that the data has drifted. Responsive to determining that data has drifted, an action is taken with respect to the machine learning model to mitigate the data drift.

Further features and advantages, as well as the structure and operation of various example embodiments, are described in detail below with reference to the accompanying drawings. It is noted that the example implementations are not limited to the specific embodiments described herein. Such example embodiments are presented herein for illustrative purposes only. Additional implementations will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate example embodiments of the present application and, together with the description, further serve to explain the principles of the example embodiments and to enable a person skilled in the pertinent art to make and use the example embodiments.

FIG. 1 shows a block diagram of a system for detecting data drift in accordance with an example embodiment.

FIG. 2 depicts a diagram of an autoencoder in accordance with an example embodiment.

FIG. 3 shows a flowchart of a method for detecting data drift in accordance with an example embodiment.

FIG. 4 shows a flowchart of a method for normalizing the plurality of importance values in accordance with an example embodiment.

FIG. 5 depicts a block diagram of a data drift determiner in accordance with an example embodiment.

FIG. 6 shows a flowchart of a method for determining a re-construction loss of an autoencoder in accordance with an example embodiment.

FIG. 7 is a block diagram of an example processor-based computer system that may be used to implement various embodiments.

The features and advantages of the implementations described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose numerous example implementations. The scope of the present application is not limited to the disclosed implementations, but also encompasses combinations of the disclosed implementations, as well as modifications to the disclosed implementations. References in the specification to “one implementation,” “an implementation,” “an example embodiment,” “example implementation,” or the like, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of persons skilled in the relevant art(s) to implement such feature, structure, or characteristic in connection with other implementations whether or not explicitly described.

In the discussion, unless otherwise stated, adjectives such as “substantially” and “about” modifying a condition or relationship characteristic of a feature or features of an implementation of the disclosure, should be understood to mean that the condition or characteristic is defined to within tolerances that are acceptable for operation of the implementation for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous example embodiments are described as follows. It is noted that any section/subsection headings provided herein are not intended to be limiting. Implementations are described throughout this document, and any type of implementation may be included under any section/subsection. Furthermore, implementations disclosed in any section/subsection may be combined with any other implementations described in the same section/subsection and/or a different section/subsection in any manner.

### II. Example Implementations

Organizations take several important decisions based on the outputs of ML models. If the performance of the ML models drops, it can have several repercussions on the organization that include outage of software systems, dissatisfied customers, and loss of sales due to faulty products. When the models are in production and degrade or suffer from under performance, it is referred to as drift. There are three types of drift. First is data drift, where the data on which the model is predicting becomes significantly different than the data the model was trained on. This is the most common type of data drift, as the data can change due to a variety of reasons. Second is model drift, where the model performance continually degrades on either of the holdout dataset or on the real-world runs. Third is concept drift, where the target definition changes over time. Model drift happens over very long time periods, as for most of the time, the model rarely changes.

The embodiments described herein are directed to neural network-based drift detection techniques for detecting data drift. For example, feature importance values of features provided to a machine learning model may be determined. An input feature vector comprising a plurality of feature values are provided as an input to a self-supervised neural network, such as an autoencoder, which is configured to learn encodings representative of the feature values provided thereto and regenerate the feature values based on the encodings. The loss function (or re-construction loss) of the autoencoder is weighted by the feature importance values. A re-construction error based on the weighted loss is determined. The re-construction error is compared to a threshold condition. In response to determining that the re-construction error meets the threshold condition, a determination is made that the data has drifted. Responsive to determining that data has drifted, an action is taken with respect to the machine learning model to mitigate the data drift.

The embodiments described herein advantageously reduce and/or prevent the usage of machine learning models experiencing data drift. By doing so, the expenditure of compute resources (e.g., CPUs, storage devices, memory, power, etc.) of a computing device on which such machine learning models execute is mitigated. Accordingly, the embodiments described herein improve the functioning of the computing device on which such machine learning models are utilized, as such compute resources are conserved as a result from preventing inaccurate machine learning models from utilizing such compute resources.

The embodiments described advantageously improves the performance of machine learning models that experience data drift. As such, any technological field in which such models are utilized are also improved. For instance, consider a scenario in which a a machine learning model is used in an industrial process, such as predictive maintenance. The ability to predict disruptions to the production line in advance of that disruption taking place is invaluable to the manufacturer. It allows the manager to schedule the downtime at the most advantageous time and eliminate unscheduled downtime. Unscheduled downtime hits the profit margin hard and also can result in the loss of the customer base. It also disrupts the supply chain, causing the carrying of excess stock. A poorly-functioning machine learning model would improperly predict disruptions, and therefore, would inadvertently cause undesired downtimes that disrupt the supply chain.

Consider another scenario in which a machine learning model is used for cybersecurity. The model would predict whether code executing on a computing system is malicious and automatically cause remedial action to occur. A poorly-functioning machine learning model may mistakenly misclassify malicious code, thereby causing the code to compromise the system. By detecting issues in cases where the model performance was affected by the data drift, malicious code may be detected and mitigated, thereby improving the functioning of the computing system. In the absence of such checks, the issue would have gone unnoticed, and the faulty outputs of the model would have been used.

Consider yet another scenario in which a machine learning model is used for autonomous (i.e., self-driving) vehicles. Autonomous vehicles can get into many different situations on the road. If drivers are going to entrust their lives to self-driving cars, they need to be sure that these cars will be ready for any situation. What’s more, a vehicle should react to these situations better than a human driver would. A vehicle cannot be limited to handling a few basic scenarios. A vehicle has to learn and adapt to the ever-changing behavior of other vehicles around it. Machine learning algorithms make autonomous vehicles capable of making decisions in real time. This increases safety and trust in autonomous cars. In case the input data drifts, then the results of the model are no longer reliable and will function poorly. A poorly-functioning machine learning model may misclassify a particular situation in which the vehicle is in, thereby jeopardizing the safety of passengers of the vehicle.

Consider a further scenario in which a machine learning model is used in biotechnology for predicting a patient’s vitals, predicting whether a patient has a disease, or analyzing an X-ray or MRI. In case the input data feature distributions change, then the existing model will no longer be adequate and is deemed to be functioning poorly. A poorly-functioning machine learning model may misclassify the vitals and/or the disease or inaccurately analyze an X-ray or MRI. In such a case, the patient may not receive necessary treatment.

Consider yet another scenario in which a machine learning model is used to manage how compute resources are allocated on a computing device or a computer network (e.g., a cloud-based computing network). In case the input data drifts, then the model will perform very poorly as it was not trained to function on the drifted data. In this scenario, improving the machine learning model will improve the functioning of the computer (or computer network) itself by properly allocating compute resources.

These examples are just a small sampling of technologies that would be improved with more accurate machine learning models. Embodiments for improved matching learning models are described as follows.

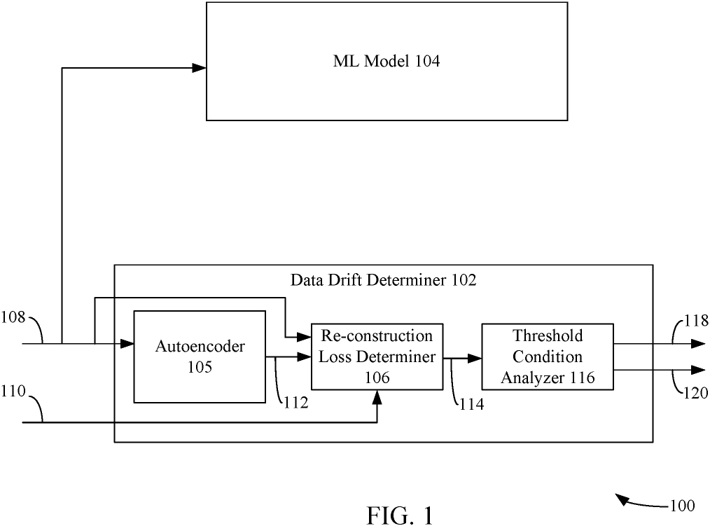

For example, FIG. 1 shows a block diagram of a system 100 for detecting data drift, according to an example embodiment. As shown in FIG. 1, system 100 may comprise a data drift determiner 102 and a machine learning (ML) model 104. Data drift determiner 102 may comprise an autoencoder 105, a re-construction loss determiner 106, and a threshold condition analyzer 116. Data drift determiner 102 is configured to receive one or more input feature vector(s) 108, each comprising a plurality of feature values utilized to train and/or build a machine learning model (e.g., machine learning model 104) and/or have a non-zero relative normalized importance (the features with zero relative normalized importance may also be included, but it is redundant, as it does not in any way contribute to the loss). Machine learning model 104 may be a neural network-based machine learning model (e.g., an artificial neural network-based machine learning model, a convolutional neural network-based machine learning model, a recurrent neural network machine learning model, etc.), or any other type of machine learning model. Input feature vector(s) 108 may comprise any number and/or types of features. Examples of features include, but are not limited to, edges, curves, colors, shapes, text, keywords, etc. It is noted that data drift determiner 102 (and the components thereof) are not incorporated within machine learning model 104.

Data drift determiner 102 is further configured to receive feature importance values 110 for the feature values of input feature vector(s) 108. Feature importance values 110 may be user-defined or automatically determined by and/or provided as an output from machine learning model 104. Feature importance values 110 may be stored in a data structure (e.g., a table, a data file, etc.). Each feature importance value of feature importance values 110 may be associated with a feature of input feature vector(s) 108. Each feature importance value may be a value ranging from 0.0 to 1.0, where higher the value, the more important the feature is for machine learning model 104 (e.g., for performing a classification). Data drift determiner 102 may be configured to normalize feature importance values 110 such that the total of all input feature importance values 110 is equal to 1. In accordance with an embodiment, to determine a normalized feature importance value for a particular feature, data drift determiner 102 first divides the feature importance value of the feature by the sum of all of feature importance values 110 to get the normalized feature importance values. It is noted that the values described above are purely exemplary and that other values may be utilized for feature importance values 110.

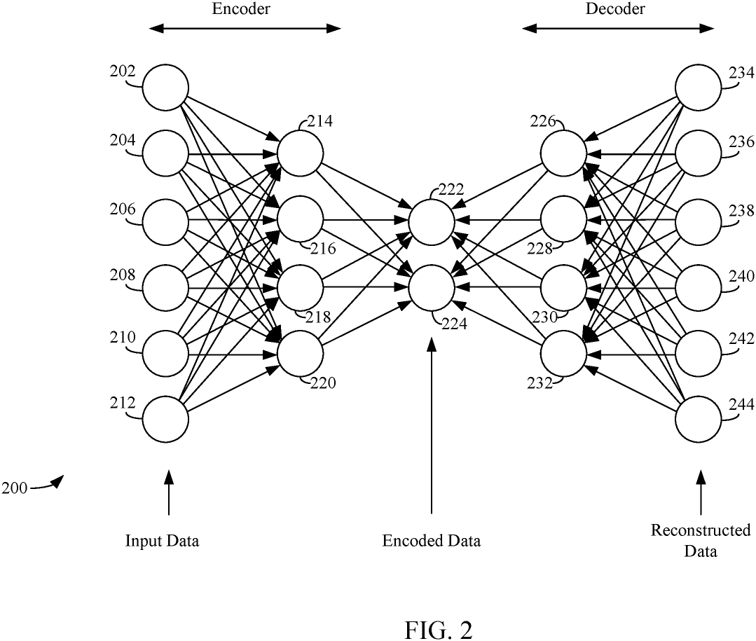

Input feature vector(s) 108 are provided to autoencoder 105. Autoencoder 105 may comprise a self-supervised neural network. In accordance with an embodiment, an autoencoder 105 is an autoencoder. For example, FIG. 2 depicts a diagram of an autoencoder 200 in accordance with an example embodiment. Autoencoder 200 is an example of autoencoder 105. Autoencoder 200 is configured to learn data encodings representative of the feature values of input feature vector(s) 108, for example, in a semi-supervised manner. The aim of autoencoder 200 is to learn a lower-dimensional representation (e.g., a semantic representation) for higher-dimensional data (i.e., input feature vector(s) 108). As shown in FIG. 2, autoencoder comprises a plurality of nodes 202-244.

Each of nodes 202-244 are associated with a weight, which emphasizes the importance of a particular node (also referred to as a neuron). For instance, suppose a neural network is configured to classify whether an image comprises a dog. In this case, nodes representing features of dog would be weighed more than features that are atypical of a dog. The weights of a neural network are initialized randomly and are learned through training on a training data set through a process of stochastic gradient descent to reduce the loss as described below. The neural network executes multiple times, changing its weights through backpropagation with respect to a loss function. In essence, the neural network tests data, makes predictions, and determines a score representative of its accuracy. Then, it uses this score to make itself slightly more accurate by updating the weights accordingly. Through this process, a neural network can learn to improve the accuracy of its predictions.

Autoencoder 200 generally comprises three parts: an encoder, a bottleneck, and a decoder, each of which comprising one or more nodes. The encoder may be represented by nodes 202-220. Nodes 202, 204, 206, 208, 210, and 212 may represent an input layer by which input data (e.g., input feature vector(s) 108, as shown in FIG. 1) are received by autoencoder 200. The encoder (or encoder network) encodes the input data (i.e., input feature vector(s) 108) into increasingly lower dimensions. That is, the encoder is configured to compress the input data (i.e., input feature vector(s) 108) into an encoded representation that is typically several orders of magnitude smaller than the input data. The encoder may perform a set of convolutional and pooling operations that compress the input data into the bottleneck (which is represented by nodes 222 and 224). The bottleneck is configured to restrict the flow of data to the decoder from the encoder to force a compressed knowledge representation of input feature vector(s) 108. The decoder may be represented by nodes 226-244. The decoder (or decoder network) is configured to decode input feature vector(s) 108 into higher increasingly higher dimensions. That is, the decoder is configured to decompress the knowledge representations and reconstruct input feature vector(s) 108 back from their encoded form. Nodes 234-244 may represent an output layer by which the reconstructed data (representative of input feature vector(s) 108 and shown as reconstructed data 112 in FIG. 1) is represented and/or provided.

Autoencoders, such as autoencoder 200 are utilized for deep learning techniques; in particular, autoencoders are a type of a neural network. The loss function used to train an autoencoder (e.g., autoencoder 200) is also referred to the re-construction loss or error, as it is a check of how well input feature vector(s) 108 are reconstructed by autoencoder 200. The re-construction error is typically the mean-squared-error (e.g., the distance between input feature vector(s) 108 and reconstructed data 112). Every layer of autoencoder 200 has an affine transformation (e.g., Wx+b, where x corresponds to a column vector corresponding to a sample from the dataset (e.g., input feature vector(s) 108) that is provided to autoencoder 200, W corresponds to the weight matrix, and b corresponds to a bias vector) followed by a non-linear function (for example, a rectified linear unit function (or ReLU function) that forces negative values to zero and maintains the value for non-negative values). In the forward pass, the predicted values are computed followed by the loss computation, with all the weights of nodes 202-244 initially set to random, and updated iteratively. In the next step, the gradients are computed to alter the weights in a direction that reduces the loss. The process is repeated till convergence. This process is referred to as stochastic gradient descent. Autoencoders are very commonly applied to anomaly detection problems. The idea is that the anomalous observations are harder to re-construct.

Referring again to FIG. 1, re-construction loss determiner 106 may be configured to determine the mean squared error between each piece of data provided to autoencoder 105 (i.e., input feature vector(s) 108) and the reconstructed version of that data (i.e., reconstructed data 112). For instance, re-construction loss determiner 106 may square the difference between the value of node 234 and the value of node 202 to generate a first loss value, may square the difference between the value of node 236 and the value of node 204 to generate a second loss value, may square the difference the difference between the value of node 238 and the value of node 206 to generate a third loss value, may square the difference the difference between the value of node 240 and the value of node 208 to generate a fourth loss value, may square the difference the difference between the value of node 242 and the value of node 210 to generate a fifth loss value, may square the difference the difference between the value of node 244 and the value of node 212 to generate a sixth loss value, and so on and so forth.

Re-construction loss determiner 106 may then weight each of the determining loss values by its corresponding normalized feature importance value. For example, re-construction loss determiner 106 may multiply the first loss value by the normalized feature importance value determined for the feature provided to node 202 and reconstructed via node 234, may multiply the second loss value by the normalized feature importance value determined for the feature provided to node 204 and reconstructed via node 236, may multiply the third loss value by the normalized feature importance value determined for the feature provided to node 206 and reconstructed via node 238, may multiply the fourth loss value by the normalized feature importance value determined for the feature provided to node 208 and reconstructed via node 240, may multiply the fifth loss value by the normalized feature importance value determined for the feature provided to node 210 and reconstructed via node 242, may multiply the sixth loss value by the normalized feature importance value determined for the feature provided to node 212 and reconstructed via node 244, and so on and so forth. To determine the total, weighted re-construction loss value (shown as weighted re-construction loss value 114), re-construction loss determiner 106 may sum the determined weighted loss values and divide the weighted, summed values by the total number of weighted loss values.

Whenever the data (i.e., the data set provided to machine learning model 104) has drifted, weighted re-construction loss value 114 will be relatively high. However, the weighting of the loss function, as described above, ensures that the re-construction error is relatively high only when the features that are most important to machine learning model 104 have drifted. Accordingly, the embodiments described herein provide a unique signature to input feature vector(s) 108, which provides higher weights to the most important features of machine learning model 104, and provides a way to detect the change in signature as the data drifts with respect to the most important features.

For example, consider a scenario in which five feature values are provided to autoencoder 105, and features 1 and 5 have a relatively high importance value. Suppose the re-construction loss with respect to features 2-4 are relatively high, but the re-construction loss with respect to features 1 and 5 are relatively low. In this case, the total re-construction loss value would be relatively low because the re-construction loss is attributed to features that are considered to have relatively low importance. A conventional re-construction loss value would be relatively high, as the feature importance values are not weighted. This would cause one to unnecessarily re-train machine learning model 104, as the assumption would be that the data provided to machine learning model 104 has drifted. However, in accordance with the embodiments described herein, weighted re-construction loss value 114, in this example, would be relatively low because the feature values having relatively high importance are reconstructed accurately. Accordingly, machine learning model 104 would not need to be re-trained in this instance.

In accordance with an embodiment, weighted re-construction loss value 114 is determined in accordance with Equations 1-6, which are provided below:

$${E}_{k} = R e L U \left({E}_{k - 1} . {W}_{k}\right) {\text{where E}}_{0} = X \qquad \text{(Equation 1)}$$

$${D}_{k} = R e L U \left({D}_{k - 1} . {W}_{k}\right) \text{where} {D}_{0} = {E}_{l a s t} \qquad \text{(Equation 2)}$$

$$e n c o d e r \left(X\right) = R e L U \left(R e L U \left(X . {W}_{1}\right) . {W}_{2}\right) \qquad \text{(Equation 3)}$$

$$d e c o d e r \left(X\right) = R e L U \left(e n c o d e r \left(X\right) . {W}_{3}\right) \qquad \text{(Equation 4)}$$

$$d e c o d e r \left(X\right) = R e L U \left(R e L U \left(e n c o d e r \left(X\right) . {W}_{3}\right) . {W}_{4}\right) \qquad \text{(Equation 5)}$$

$$D A W L l o s s = F ∗ {\left(d e c o d e r \left(e n c o d e r \left(X\right)\right) - X\right)}^{2} \qquad \text{(Equation 6)}$$

Input feature vector(s) 108 for machine learning model 104 is denoted by X, which is a m * n matrix with m rows and n columns. Every layer of the encoder of autoencoder 105 applies the function shown in Equation 1, where k is the k^{th} layer of the autoencoder and Wₖ is the weight matrix for layer k in the network. Every layer of the decoder of autoencoder 104 applies function in Equation 2. The decoder formulas are the mirror images of the encoder, as shown in Equation 2. In an example in which there is one encoder and one decoder layer, Equations 3-5 demonstrate the outputs from the encoder and decoder stages. Denoting F to be the relative normalized feature importance (e.g., feature importance values 110) for machine learning model 104, the Euclidean distance between the re-constructed input and the original input, is the loss, and is denoted by Equation 6.

Weighted re-construction loss value 114 is provided to threshold condition analyzer 116. Threshold condition analyzer 116 is configured to determine whether weighted re-construction loss value 114 meets a threshold condition (e.g., mean plus one standard deviation, although it is noted that other threshold conditions may be utilized). If the threshold condition is met, then threshold condition analyzer 116 may determine that data drift with respect to the more important features has occurred. If the threshold condition is not met, then threshold condition analyzer 116 may determine that data drift with respect to the more important features has not occurred.

In accordance with an embodiment, the threshold condition may be a predetermined value. In accordance with such an embodiment, threshold condition analyzer 116 may be configured in one of many ways to determine that the threshold condition has been met. For instance, threshold condition analyzer 116 may be configured to determine that the threshold condition has been met if the weighted re-construction loss value 114 is less than, less than or equal to, greater than or equal to, or greater than the predetermined value.

In response to detecting that data drift has occurred with respect to the more important, threshold condition analyzer 116 may cause an action to be performed. For example, threshold condition analyzer 116 may issue a notification 118 (e.g., to an administrator) that indicates that the data drift has been detected and that indicates that machine learning model 104 should be de-activated and/or re-trained. The notification may comprise a short messaging service (SMS) message, a telephone call, an e-mail, a notification that is presented via an incident management service, etc. In another example, threshold condition analyzer 116 may cause machine learning model 104 to be automatically de-activated and/or re-trained by sending a command 120 to an application and/or service that manages machine learning model 104. Responsive to receiving command 120, the application and/or service may de-activate and/or re-train machine learning model 104.

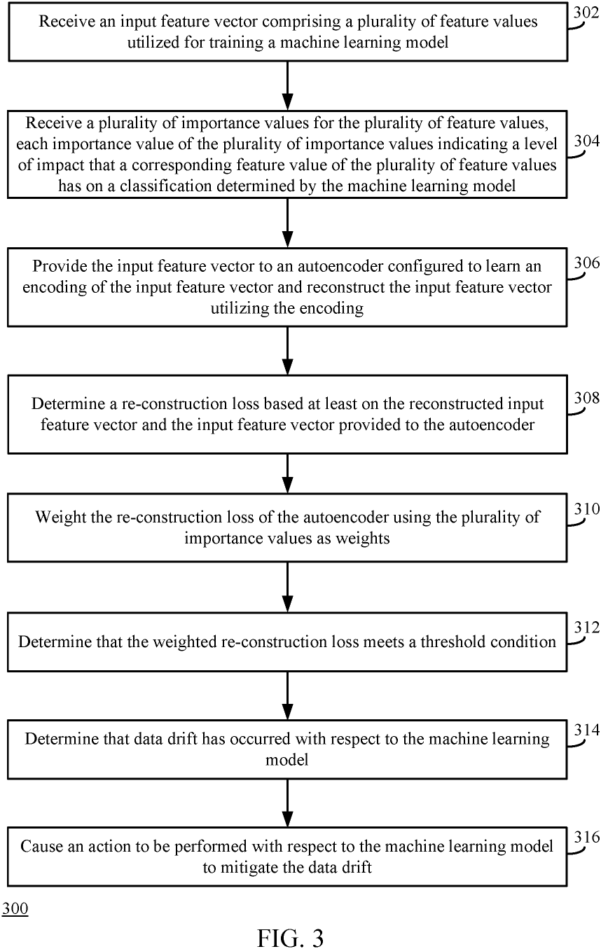

Accordingly, the detection of data drift may be detected be implemented in many ways. For example, FIG. 3 shows a flowchart 300 of a method for detecting data drift in accordance with an example embodiment. In an embodiment, flowchart 300 may be implemented by data drift determiner 102, as shown in FIG. 1, although the method is not limited to that implementation. Accordingly, flowchart 300 will be described with continued reference to FIG. 1. Other structural and operational embodiments will be apparent to persons skilled in the relevant art(s) based on the discussion regarding flowchart 300 and system 100 of FIG. 1.

Flowchart 300 begins with step 302. In step 302, an input feature vector comprising a plurality of feature values utilized for training a machine learning model is received. It is noted that the input feature vector may comprise one or more input feature vectors. For example, with reference to FIG. 1, data drift determiner 102 receives input feature vector(s) 108, which is utilized for training machine learning model 104.

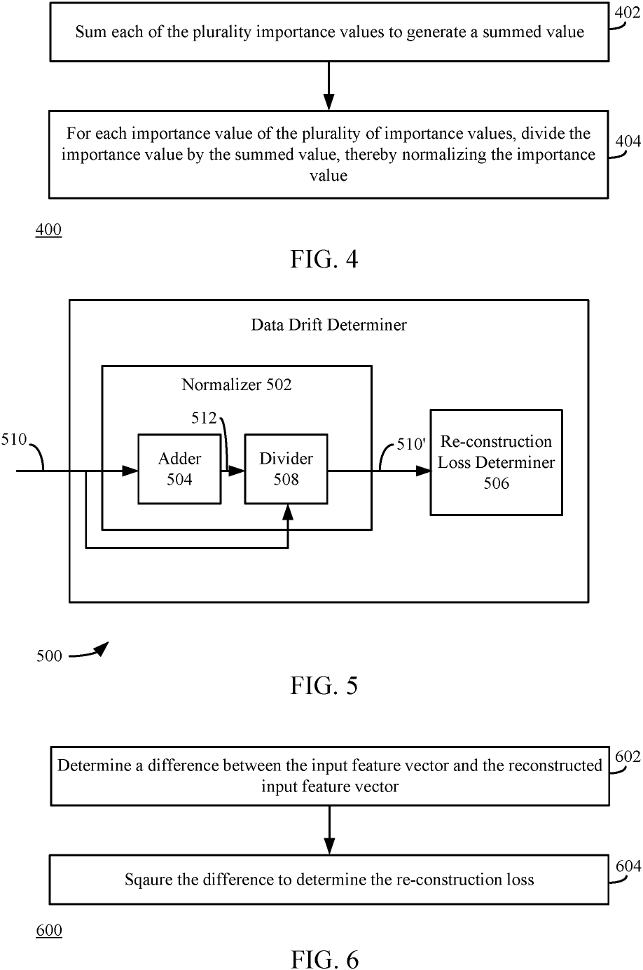

In step 304, a plurality of importance values for the plurality of feature values is received, each importance value of the plurality of importance values indicating a level of impact that a corresponding feature value of the plurality of feature values has on a classification determined by the machine learning model. For example, with reference to FIG. 1, feature importance values 110 for the plurality of feature values is received. Each importance value of the plurality of importance values indicates a level of impact that a corresponding feature value of the plurality of feature values has on a classification determined by machine learning model 104. Additional details regarding receiving the plurality of importance values are described below with reference to FIG. 4.

In step 306, the input feature vector is provided to an autoencoder configured to learn an encoding of the input feature vector and reconstruct the input feature vector utilizing the encoding. For example, with reference to FIG. 1, input feature vector(s) 108 are provided to autoencoder 105 configured to encode input feature vector(s) 108 and reconstruct input feature vector(s) 108 (shown as reconstructed data 112) utilizing the encoding.

In accordance with an embodiment, autoencoder 105 is a self-supervised neural network.

In step 308, a re-construction loss is determined based at least on the reconstructed input feature vector and the input feature vector provided to the autoencoder. For example, with reference to FIG. 1, for each feature value of the input feature vector, a re-construction loss value is determined based on the feature value and a corresponding feature value of the reconstructed input feature vector. For example, with reference to FIG. 1, for each feature value of input feature vector(s) 108, re-construction loss determiner 106 determines a re-construction loss value based on the feature value and a corresponding feature value of the reconstructed data 112.

In step 310, the re-construction loss of the autoencoder is weighted using the plurality of importance values as weights. For each re-construction loss value, the re-construction loss value is weighted with a corresponding importance value of the plurality of importance values. For example, with reference to FIG. 1, for each re-construction loss value, re-construction loss determiner 106 weights the re-construction loss value with a corresponding importance value of feature importance values 110. A total, weighted re-construction loss value is determined based on the weighted re-construction loss values. For example, with reference to FIG. 1, re-construction loss determiner 106 determines total, weighted re-construction loss value 114 based on the weighted re-construction loss values. To determine the total, weighted re-construction loss value 114, re-construction loss determiner 106 may sum the determined weighted loss values and divide the weighted, summed values by the total number of weighted loss values.

In step 312, a determination is made that the weighted re-construction loss meets a threshold condition. For example, with reference to FIG. 1, threshold condition analyzer 116 determines that weighted re-construction loss value 114 meets a threshold condition.

In step 314, responsive to determining that the weighted re-construction loss meets the threshold condition, a determination is made that data drift has occurred with respect to the machine learning model. For example, with reference to FIG. 1, responsive to determining that weighted re-construction loss 114 meets a threshold condition, threshold condition analyzer 116 determines that the data drift has occurred with respect to machine learning model 104.

In step 316, responsive to determining that the weighted re-construction loss meets the threshold condition, an action is caused to be performed with respect to the machine learning model to mitigate the data drift. For example, with reference to FIG. 1, threshold condition analyzer 116 may cause an action to be performed with respect to machine learning model 104.

In accordance with one or more embodiments, the action comprises at least one of generating a notification that indicates that the data drift has been detected or generating a command that causes the machine learning model to be re-trained or deactivated. For example, with reference to FIG. 1, threshold condition analyzer 116 may be configured to generate a notification 118 that indicates that the data drift has been detected or generate a command 120 that causes machine learning model 104 to be re-trained or deactivated.

FIG. 4 shows a flowchart 400 of a method for normalizing the plurality of importance values in accordance with an example embodiment. In an embodiment, flowchart 400 may be implemented by a data drift determiner 500, as shown in FIG. 5, although the method is not limited to that implementation. Accordingly, flowchart 400 will be described with reference to FIG. 5. FIG. 5 depicts a block diagram of data drift determiner 500 in accordance with an example embodiment. Data drift determiner 500 is an example of data drift determiner 102, as described above with reference to FIG. 1. As shown in FIG. 5, data drift determiner 500 comprises a normalizer 502 and a re-construction loss determiner 506. Re-construction loss determiner 506 is an example of re-construction loss determiner 106, as described above with reference to FIG. 1. Normalizer 502 may include an adder 504 and a divider 508. Additional components of data drift determiner 102 described above not shown with respect to data drift determiner 500 for the sake of brevity. Other structural and operational embodiments will be apparent to persons skilled in the relevant art(s) based on the discussion regarding flowchart 400 and data drift determiner 500 of FIG. 5.

Flowchart 400 begins with step 402. In step 402, each of the plurality of importance values are summed to generate a summed value. For example, with reference to FIG. 5, normalizer 502 is configured to receive feature importance values 510, which are examples of feature importance values 110. Adder 504 is configured to sum feature importance values 410 to generate a summed value 512. Summed value 512 is provided to divider 508.

In step 404, for each importance value of the plurality of importance values, the importance value is divided by the summed value, thereby normalizing the importance values. For example, with reference to FIG. 5, for each importance value of feature importance values 510, divider 508 divides the importance value by summed value 512. The normalized feature importance values (shown as normalized feature importance values 510′) are provided to re-construction loss determiner 506, and these form the weights in the weighted loss that is described as F in Equation 6 above.

In accordance with one or more embodiments, the re-construction loss of the autoencoder is weighted using the plurality of normalized importance values as weights. For example, with reference to FIG. 5, re-construction loss determiner 506 weights the re-construction loss of the autoencoder (e.g., autoencoder 105, as shown in FIG. 1) using normalized feature importance values 510′ as weights.

FIG. 6 shows a flowchart 600 of a method for determining a re-construction loss of an autoencoder in accordance with an example embodiment. In an embodiment, flowchart 600 may be implemented by re-construction loss determiner 106 of FIG. 1, although the method is not limited to that implementation. Accordingly, flowchart 600 will be described with continued reference to FIG. 1. Other structural and operational embodiments will be apparent to persons skilled in the relevant art(s) based on the discussion regarding flowchart 600 and re-construction loss determiner 106 of FIG. 1.

Flowchart 600 begins with step 602. In step 602, a difference between the input feature vector and the reconstructed input feature vector is determined. For example, with reference to FIG. 1, re-construction loss determiner 106 determines a difference between input feature vector 108 and reconstructed data 112

In step 604, the difference is squared to determine the re-construction loss. For example, with reference to FIG. 1, re-construction loss determiner 106 squares the different to determine the re-construction loss.

### III. Example Computer System Implementation

The systems and methods described above in reference to FIGS. 1-6, may be implemented in hardware, or hardware combined with one or both of software and/or firmware. For example, system 700 may be used to implement any of data drift determiner 102, machine learning model 104, autoencoder 105, re-construction loss determiner 106, and/or threshold condition analyzer 116 of FIG. 1, autoencoder 200 of FIG. 2, data drift determiner 500, normalizer 502, adder 504, divider 508, and/or re-construction loss determiner 506 of FIG. 5, and/or any of the components respectively described therein, and flowcharts 300, 400, and/or 600 may be each implemented as computer program code/instructions configured to be executed in one or more processors and stored in a computer readable storage medium. Alternatively, any of data drift determiner 102, machine learning model 104, autoencoder 105, re-construction loss determiner 106, and/or threshold condition analyzer 116 of FIG. 1, autoencoder 200 of FIG. 2, data drift determiner 500, normalizer 502, adder 504, divider 508, and/or re-construction loss determiner 506 of FIG. 5, and/or any of the components respectively described therein, and flowcharts 300, 400, and/or 600 may be implemented as hardware logic/electrical circuitry. In an embodiment, any of data drift determiner 102, machine learning model 104, autoencoder 105, re-construction loss determiner 106, and/or threshold condition analyzer 116 of FIG. 1, autoencoder 200 of FIG. 2, data drift determiner 500, normalizer 502, adder 504, divider 508, and/or re-construction loss determiner 506 of FIG. 5, and/or any of the components respectively described therein, and flowcharts 300, 400, and/or 600 may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

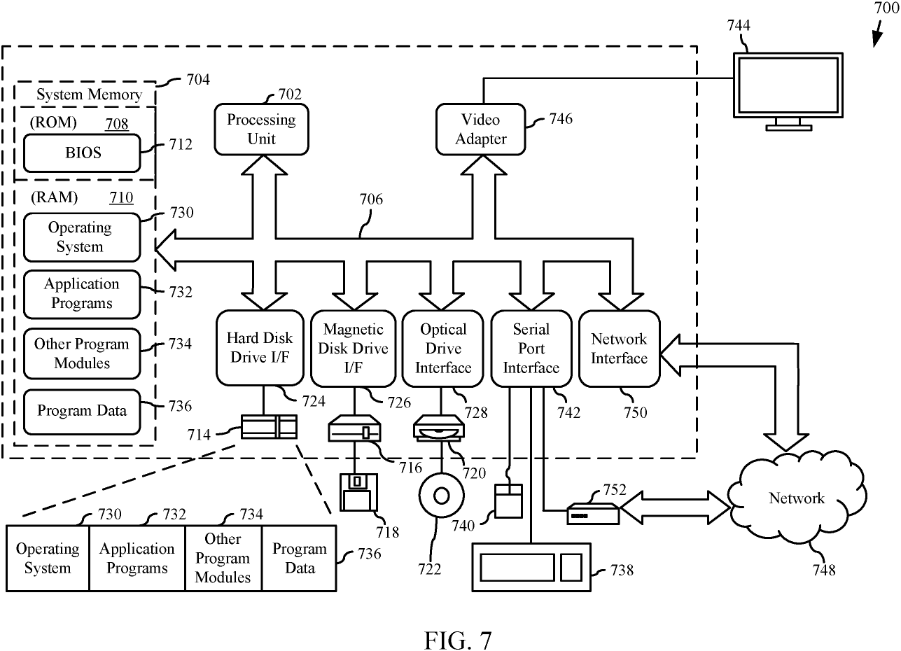

FIG. 7 depicts an exemplary implementation of a computing device 700 in which embodiments may be implemented, including any of any of data drift determiner 102, machine learning model 104, autoencoder 105, re-construction loss determiner 106, and/or threshold condition analyzer 116 of FIG. 1, autoencoder 200 of FIG. 2, data drift determiner 500, normalizer 502, adder 504, divider 508, and/or re-construction loss determiner 506 of FIG. 5, and/or any of the components respectively described therein, and flowcharts 300, 400, and/or 600. The description of computing device 700 provided herein is provided for purposes of illustration, and is not intended to be limiting. Embodiments may be implemented in further types of computer systems, as would be known to persons skilled in the relevant art(s).

As shown in FIG. 7, computing device 700 includes one or more processors, referred to as processor circuit 702, a system memory 704, and a bus 706 that couples various system components including system memory 704 to processor circuit 702. Processor circuit 702 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 702 may execute program code stored in a computer readable medium, such as program code of operating system 730, application programs 732, other programs 734, etc. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computing device 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 730, one or more application programs 732, other programs 734, and program data 736. Application programs 732 or other programs 734 may include, for example, computer program logic (e.g., computer program code or instructions) for implementing the systems described above, including the embodiments described above with reference to FIGS. 1-6.

A user may enter commands and information into the computing device 700 through input devices such as keyboard 738 and pointing device 740. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 702 through a serial port interface 742 that is coupled to bus 706, but may be connected by other interfaces, such as a parallel port, game port, or a universal serial bus (USB).

A display screen 744 is also connected to bus 706 via an interface, such as a video adapter 746. Display screen 744 may be external to, or incorporated in computing device 700. Display screen 744 may display information, as well as being a user interface for receiving user commands and/or other information (e.g., by touch, finger gestures, a virtual keyboard, by providing a tap input (where a user lightly presses and quickly releases display screen 744), by providing a “touch-and-hold” input (where a user touches and holds his finger (or touch instrument) on display screen 744 for a predetermined period of time), by providing touch input that exceeds a predetermined pressure threshold, etc.). In addition to display screen 744, computing device 700 may include other peripheral output devices (not shown) such as speakers and printers.

Computing device 700 is connected to a network 748 (e.g., the Internet) through an adaptor or network interface 750, a modem 752, or other means for establishing communications over the network. Modem 752, which may be internal or external, may be connected to bus 706 via serial port interface 742, as shown in FIG. 7, or may be connected to bus 706 using another interface type, including a parallel interface.

As used herein, the terms “computer program medium,” “computer-readable medium,” and “computer-readable storage medium” are used to generally refer to physical hardware media such as the hard disk associated with hard disk drive 714, removable magnetic disk 718, removable optical disk 722, other physical hardware media such as RAMs, ROMs, flash memory cards, digital video disks, zip disks, MEMs, nanotechnology-based storage devices, and further types of physical/tangible hardware storage media (including system memory 704 of FIG. 7). Such computer-readable storage media are distinguished from and non-overlapping with communication media and propagating signals (do not include communication media and propagating signals). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 732 and other programs 734) may be stored on the hard disk, magnetic disk, optical disk, ROM, RAM, or other hardware storage medium. Such computer programs may also be received via network interface 750, serial port interface 752, or any other interface type. Such computer programs, when executed or loaded by an application, enable computing device 700 to implement features of embodiments discussed herein. Accordingly, such computer programs represent controllers of the computing device 700.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Further Example Embodiments

A system is described herein. The system includes at least one processor circuit; and at least one memory that stores program code configured to be executed by the at least one processor circuit, the program code comprising: a data drift determiner configured to: receive an input feature vector comprising a plurality of feature values utilized for training a machine learning model; receive a plurality of importance values for the plurality of feature values, each importance value of the plurality of importance values indicating a level of impact that a corresponding feature value of the plurality of feature values has on a classification determined by the machine learning model; provide the input feature vector to an autoencoder configured to learn an encoding of the input feature vector and reconstruct the input feature vector utilizing the encoding; determine a re-construction loss based at least on the reconstructed input feature vector and the input feature vector provided to the autoencoder; weight the re-construction loss of the autoencoder using the plurality of importance values as weights; determine that the weighted re-construction loss meets a threshold condition; and responsive to a determination that the weighted re-construction loss meets the threshold condition: determine that data drift has occurred with respect to the machine learning model; and cause an action to be performed with respect to the machine learning model to mitigate the data drift.

In an implementation of the system, the action comprises at least one of: generating a notification that indicates that the data drift has been detected; or generating a command that causes the machine learning model to be re-trained or deactivated.

In an implementation of the system, the autoencoder is a self-supervised neural network.

In an implementation of the system, the data drift determiner is configured to receive the plurality of importance values for the plurality of feature values by: summing each of the plurality of importance values to generate a summed value; and for each importance value of the plurality of importance values, dividing the importance value by the summed value, thereby normalizing the importance value.

In an implementation of the system, the data drift determiner is configured to weight the re-construction loss of the autoencoder using the plurality of importance values as weights by: weighting the re-construction loss of the autoencoder using the plurality of normalized importance values as weights.

In an implementation of the system, the data drift determiner is configured to determine the re-construction loss by: determining a difference between the input feature vector and the reconstructed input feature vector; and squaring the difference to determine the re-construction loss.

In an implementation of the system, the plurality of importance values is at least one of: user-defined; or provided as an output from the machine learning model.

A method is also described herein. The method includes: receiving an input feature vector comprising a plurality of feature values utilized for training a machine learning model; receiving a plurality of importance values for the plurality of feature values, each importance value of the plurality of importance values indicating a level of impact that a corresponding feature value of the plurality of feature values has on a classification determined by the machine learning model; providing the input feature vector to an autoencoder configured to learn an encoding of the input feature vector and reconstruct the input feature vector utilizing the encoding; determining a re-construction loss based at least on the reconstructed input feature vector and the input feature vector provided to the autoencoder; weighting the re-construction loss of the autoencoder using the plurality of importance values as weights; determining that the weighted re-construction loss meets a threshold condition; and responsive to determining that the weighted re-construction loss meets the threshold condition: determining that data drift has occurred with respect to the machine learning model; and causing an action to be performed with respect to the machine learning model to mitigate the data drift.

In an implementation of the method, the action comprises at least one of: generating a notification that indicates that the data drift has been detected; or generating a command that causes the machine learning model to be re-trained or deactivated.

In an implementation of the method, the autoencoder is a self-supervised neural network.

In an implementation of the method, receiving a plurality of importance values for the plurality of feature values comprises: summing each of the plurality of importance values to generate a summed value; and for each importance value of the plurality of importance values, dividing the importance value by the summed value, thereby normalizing the importance value.

In an implementation of the method, weighting the re-construction loss of the autoencoder using the plurality of importance values as weights comprises: weighting the re-construction loss of the autoencoder using the plurality of normalized importance values as weights.

In an implementation of the method, the re-construction loss is determined by: determining a difference between the input feature vector and the reconstructed input feature vector; and squaring the difference to determine the re-construction loss.

In an implementation of the method, the plurality of importance values is at least one of: user-defined; or provided as an output from the machine learning model.

A computer-readable storage medium having program instructions recorded thereon that, when executed by at least one processor, perform a method is further described herein. The method includes: receiving an input feature vector comprising a plurality of feature values utilized for training a machine learning model; receiving a plurality of importance values for the plurality of feature values, each importance value of the plurality of importance values indicating a level of impact that a corresponding feature value of the plurality of feature values has on a classification determined by the machine learning model; providing the input feature vector to an autoencoder configured to learn an encoding of the input feature vector and reconstruct the input feature vector utilizing the encoding; determining a re-construction loss based at least on the reconstructed input feature vector and the input feature vector provided to the autoencoder; weighting the re-construction loss of the autoencoder using the plurality of importance values as weights; determining that the weighted re-construction loss meets a threshold condition; and responsive to determining that the weighted re-construction loss meets the threshold condition: determining that data drift has occurred with respect to the machine learning model; and causing an action to be performed with respect to the machine learning model to mitigate the data drift.

In an implementation of the computer-readable storage medium, the action comprises at least one of: generating a notification that indicates that the data drift has been detected; or generating a command that causes the machine learning model to be re-trained or deactivated.

In an implementation of the computer-readable storage medium, the autoencoder is a self-supervised neural network.

In an implementation of the computer-readable storage medium, receiving a plurality of importance values for the plurality of feature values comprises: summing each of the plurality of importance values to generate a summed value; and for each importance value of the plurality of importance values, dividing the importance value by the summed value, thereby normalizing the importance value.

In an implementation of the computer-readable storage medium, weighting the re-construction loss of the autoencoder using the plurality of importance values as weights comprises: weighting the re-construction loss of the autoencoder using the plurality of normalized importance values as weights.

In an implementation of the computer-readable storage medium, the re-construction loss is determined by: determining a difference between the input feature vector and the reconstructed input feature vector; and squaring the difference to determine the re-construction loss.

### V. Conclusion

While various example embodiments have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosure should not be limited by any of the above-described example embodiments, but should be defined only in accordance with the following claims and their equivalents.

What is claimed is:

1. A system, comprising:
at least one processor circuit; and
at least one memory that stores program code configured to be executed by the at least one processor circuit, the program code comprising:
a data drift determiner configured to:
receive an input feature vector comprising a plurality of feature values utilized for training a machine learning model;
receive a plurality of importance values for the plurality of feature values, each importance value of the plurality of importance values indicating a level of impact that a corresponding feature value of the plurality of feature values has on a classification determined by the machine learning model;
provide the input feature vector to an autoencoder configured to learn an encoding of the input feature vector and reconstruct the input feature vector utilizing the encoding;
determine a re-construction loss based at least on the reconstructed input feature vector and the input feature vector provided to the autoencoder;
weight the re-construction loss of the autoencoder using the plurality of importance values as weights;
determine that the weighted re-construction loss meets a threshold condition; and
responsive to a determination that the weighted re-construction loss meets the threshold condition:
determine that data drift has occurred with respect to the machine learning model; and
cause an action to be performed with respect to the machine learning model to mitigate the data drift.

2. The system of claim 1, wherein the action comprises at least one of:
generating a notification that indicates that the data drift has been detected; or
generating a command that causes the machine learning model to be re-trained or deactivated.

3. The system of claim 1, wherein the autoencoder is a self-supervised neural network.

4. The system of claim 1, wherein the data drift determiner is configured to receive the plurality of importance values for the plurality of feature values by:
summing each of the plurality of importance values to generate a summed value; and
for each importance value of the plurality of importance values, dividing the importance value by the summed value, thereby normalizing the importance value.

5. The system of claim 4, wherein the data drift determiner is configured to weight the re-construction loss of the autoencoder using the plurality of importance values as weights by;
weighting the re-construction loss of the autoencoder using the plurality of normalized importance values as weights.

6. The system of claim 1, wherein the data drift determiner is configured to determine the re-construction loss by:
determining a difference between the input feature vector and the reconstructed input feature vector; and
squaring the difference to determine the re-construction loss.

7. The system of claim 1, wherein the plurality of importance values is at least one of:
user-defined; or
provided as an output from the machine learning model.

8. A method, comprising:
receiving an input feature vector comprising a plurality of feature values utilized for training a machine learning model;
receiving a plurality of importance values for the plurality of features values, each importance value of the plurality of importance values indicating a level of impact that a corresponding feature value of the plurality of feature values has on a classification determined by the machine learning model;
providing the input feature vector to an autoencoder configured to learn an encoding of the input feature vector and reconstruct the input feature vector utilizing the encoding;
determining a re-construction loss based at least on the reconstructed input feature vector and the input feature vector provided to the autoencoder;
weighting the re-construction loss of the autoencoder using the plurality of importance values as weights;
determining that the weighted re-construction loss meets a threshold condition; and
responsive to determining that the weighted re-construction loss meets the threshold condition:
determining that data drift has occurred with respect to the machine learning model; and
causing an action to be performed with respect to the machine learning model to mitigate the data drift.

9. The method of claim 8, wherein the action comprises at least one of:
generating a notification that indicates that the data drift has been detected; or
generating a command that causes the machine learning model to be re-trained or deactivated.

10. The method of claim 8, wherein the autoencoder is a self-supervised neural network.

11. The method of claim 8, wherein receiving a plurality of importance values for the plurality of feature values comprises:
summing each of the plurality of importance values to generate a summed value; and
for each importance value of the plurality of importance values, dividing the importance value by the summed value, thereby normalizing the importance value.

12. The method of claim 11, wherein weighting the re-construction loss of the autoencoder using the plurality of importance values as weights comprises:
weighting the re-construction loss of the autoencoder using the plurality of normalized importance values as weights.

13. The method of claim 8, wherein the re-construction loss is determined by:
determining a difference between the input feature vector and the reconstructed input feature vector; and
squaring the difference to determine the re-construction loss.

14. The method of claim 8, wherein the plurality of importance values is at least one of:
user-defined; or
provided as an output from the machine learning model.

15. A computer-readable storage medium having program instructions recorded thereon that, when executed by at least one processor, perform a method comprising:
receiving an input feature vector comprising a plurality of feature values utilized for training a machine learning model;
receiving a plurality of importance values for the plurality of feature values, each importance value of the plurality of importance values indicating a level of impact that a corresponding feature value of the plurality of feature values has on a classification determined by the machine learning model;
providing the input feature vector to an autoencoder configured to learn an encoding of the input feature vector and reconstruct the input feature vector utilizing the encoding;
determining a re-construction loss based at least on the reconstructed input feature vector and the input feature vector provided to the autoencoder;
weighting the re-construction loss of the autoencoder using the plurality of importance values as weights;
determining that the weighted re-construction loss meets a threshold condition; and
responsive to determining that the weighted re-construction loss meets the threshold condition:
determining that data drift has occurred with respect to the machine learning model; and
causing an action to be performed with respect to the machine learning model to mitigate the data drift.

16. The computer-readable storage medium of claim 15, wherein the action comprises at least one of:
generating a notification that indicates that the data drift has been detected; or
generating a command that causes the machine learning model to be re-trained or deactivated.

17. The computer-readable storage medium of claim 15, wherein the autoencoder is a self-supervised neural network.

18. The computer-readable storage medium of claim 15, wherein receiving a plurality of importance values for the plurality of feature values comprises:
summing each of the plurality of importance values to generate a summed value; and
for each importance value of the plurality of importance values, dividing the importance value by the summed value, thereby normalizing the importance value.

19. The computer-readable storage medium of claim 18, wherein weighting the re-construction loss of the autoencoder using the plurality of importance values as weights comprises:
weighting the re-construction loss of the autoencoder using the plurality of normalized importance values as weights.

20. The computer-readable storage medium of claim 15, wherein the re-construction loss is determined by:
determining a difference between the input feature vector and the reconstructed input feature vector; and
squaring the difference to determine the re-construction loss.
